(19) United States
(12) Patent Application Publication
(10) Pub. No.: US 2010/0177887 A1
(43) Pub. Date: Jul. 15, 2010

(54) MONTGOMERY-BASED MODULAR EXPONENTIATION SECURED AGAINST HIDDEN CHANNEL ATTACKS

(75) Inventors: Mathieu Ciet, St Cyr Sur Mer (FR); Benoit Feix, La Ciotat (FR)

Correspondence Address: BUCHANAN, INGERSOLL & ROONEY PC, POST OFFICE BOX 1404, ALEXANDRIA, VA, 22313-1404, US

(73) Assignee: GEMALTO SA, Meudon (FR)

(21) Appl. No.: 12/666,892

(22) PCT Filed: May 2, 2008
(86) PCT No.: PCT/EP08/55427

§ 371 Date: Dec. 28, 2009

(30) Foreign Application Priority Data
Jun. 29, 2007 (EP) 07301194.2

(51) Int. Cl. H04L 9/28

(52) U.S. Cl. 380/28

(57) ABSTRACT

The invention relates to a cryptographic method that incorporates a modular exponentiation secured against hidden channel attacks, without requiring knowledge of the public exponent. The method includes a modular exponentiation and the following steps: drawing of a random value s; initialization of variables with the aid of s; application of an algorithm enabling a loop invariant to be retained by virtue of the properties of the Montgomery multiplier Mgt; unmasking of the result of the algorithm to obtain the signature of the message.

The invention relates to a cryptographic method comprising a modular exponentiation secured against hidden channel attacks not requiring the knowledge of the public exponent, a crytoprocessor for implementing the method and an associated chip card.

The invention more particularly concerns a cryptographic method secured against hidden channel attacks during which, to perform a modular exponentiation of the S=M^{d} mod N type, where M is an operand, d is a first exponent, N is a module and S is a result.

Such methods are more particularly interesting for asymmetric signature and decrypting applications. According to the application, M is then a message to be signed or to be decrypted. d is a private key. S is a result, according to the application a signed or a decrypted message.

Masking the number M by a random number s is a known countermeasure for securing modular exponentiation operations, more particularly when they are implemented in microcircuits of the chip card type against so-called side channel attacks or hidden channel attacks which make it possible to obtain information on the number d.

A first known countermeasure of the document entitled “Timing Attack on Implementations of Diffie-Hellman, RSA, DSS and Other Systems”, by Paul Kocher, Crypto 1996, LNCS Springer, consists in drawing a random s, calculating s^{e}, where e is a private or a public key associated to d, then multiplying M by s^{e} (s^{e}·M), raise the result of the multiplication to the power of d ((s^{e}·M)^{d}), then reduce modulo N. d and e being a public key and an associated private key, we have d·e=1 modulo φ(N), where φ represents Euler's function so that the result ((s^{e}·M)^{d}) modulo N is simplified to give (s·M^{d}) modulo N. A modular division by s finally makes it possible to obtain the searched result S=M^{d} mod N. This solution is efficient indeed but the implementation thereof is expensive. As a matter of fact, for the measure to be efficient, it is indispensable for s^{e} to be of a larger size than the size of M. This assumes that s is of a large size, more precisely of a larger size than the size of M divided by e. If e is of a small size (for example less than seventeen), s must be of a large size (in the example, larger than the number of bits of the module divided by seventeen). Producing large size random numbers requires the utilization of a large size generator which on the one hand consumes a large quantity of current and on the other hand requires a relatively significant calculation time which is not always compatible with applications of the chip card type.

A second countermeasure more particularly known from the document by J. S. Coron, P. Paillier “Countermeasure method in an electronic component which uses on RSA-type public key cryptographic algorithm” Patent number Fr 2799851. Publication date 2001-04-20. Int Pub Numb. WO0128153, consists in using two random numbers s1, s2 to perform the operation (M+s1·N)^{d} mod (s2·N). Then, the contribution brought by s1 and s2 is removed at the end of the calculation by performing a reduction modulo N. As s1 and s2 can be of a small size, obtaining them is easier. However, this method requires performing operations modulo s2·N. This requires using a multiplier of a larger size than the module and is not always compatible with applications of the chip card type.

Such countermeasures have the main drawback of requiring knowing the value of e, a public exponent, or of requiring a cryptoprocessor of a larger size than that of the module.

One aim of the invention is to provide a solution to perform a modular operation of the M^{d} mod N type more interesting than the known solutions since it does not require knowing e, nor a cryptoprocessor of a size larger than that of the module.

Therefore, the invention provides to efficiently protect the operation of exponentiation by a random mask without knowing e.

It should be noted that, in this document

Mgt (A, B, N) the modular multiplication of Montgomery of A by B modulo N,

A and B two integers,

N the selected modulo defines the assembly {0, . . . , N−1} of the integers in which the operations are performed,

n=the number of bits of N or the length of N in base 2,

R=2ⁿ, a co-prime constant with N, and which depends on the size of N,

M the message to be signed or decrypted,

S the signature of the message M or the decrypted message.

The invention is a cryptographic method intended to sign or decrypt a message M, including a modular exponentiation including the following steps:

drawing of a random value s,

initialization of variables with the aid of s,

application of an algorithm enabling a loop invariant to be retained by virtue of the properties of the Montgomery multiplier Mgt,

unmasking of the result in order to obtain the result S, according to the cases, corresponding to the signature of M or to the decrypted message.

In one embodiment, the pre-calculation step may include the step of initialization using a value j, calculated by j=(3s)/2, a selected module N, the Montgomery variable R and includes the initialization of at least five variables Acc, M₂, M₀, M₁ and M₃ according to the following operations:
Acc←R^{s+1}·M mod N
M₂←R^{-j+1} mod N
M₀←R^{-3s+1} mod N
M₁←R^{-3s+1}·M mod N
M₃←R^{-3s+1}·M³ mod N

In this case, the algorithm may include, for each bit of the exponent d, the following steps:
squaring Acc←Mgt(Acc, Acc, N),
initialization of a variable k, so that k=dᵢdᵢ₋₁,
if k=2
   Acc←Mgt(Acc, M₂, N)
   Acc←Mgt(Acc, Acc, N)
if not so
   Acc←Mgt(Acc, Acc, N)
   Acc←Mgt(Acc, Mₖ, N)
Shift two bits.

In another embodiment, the step of initialization uses a selected module N, the Montgomery variable R and includes the initialization of at least four variables Acc, M₀, M₁ and M₃ according to the following operations:
Acc←R^{s+1}·M mod N
M₀←R^{-s+1} mod N
M₁←R^{-s+1}·M mod N
M₃←R^{-3s+1}·M³ mod N

In this case, the algorithm includes, for each bit of the exponent d, the following steps:
squaring Acc←Mgt(Acc, Acc, N)
if the current bit is equal to 1 and the next bit too, then
   Acc←Mgt(Acc, Acc, N)
   Acc←Mgt(Acc, M₃, N)
   shift two bits.
if the current bit is equal to 1 and the next bit is equal to 0, then
   Acc←Mgt(Acc, M₁, N)
   shift one bit.
if the current bit is equal to 0, then
   Acc←Mgt(Acc, M₀, N),
   shift one bit.

In any case, the unmasking operation includes at least the following operations:
calculation of R^{-s},
calculation of the signature S of said message M, S=Mgt(Acc, R^{-s}, N), depending on the case, corresponding to the signature of M or to the decrypted message.

The invention thus makes it possible to efficiently protect the operation of exponentiation by a random mask, the reverse of which can be easily calculated without randomizing the module.

The invention also relates to a cryptoprocessor more particularly including a Montgomery multiplier for implementing a method as described hereabove.

Finally, the invention relates to a chip card including a cryptoprocessor such as described hereabove.

As mentioned above, the invention relates to a cryptographic method intended to sign or to decrypt a message M, including a modular exponentiation including the following steps:
drawing of a random value s
initialization of variables with the aid of s
application of an algorithm enabling a loop invariant to be retained by virtue of the properties of the Montgomery multiplier Mgt,
unmasking of the result in order to obtain the signature s of the message M.

The invention is preferably implemented using the Montgomery multiplier.

Prior to describing more thoroughly the method of the invention, a few known properties of the Montgomery multiplier should be reminded, as described for example in the document D3 (P. L. Montgomery, Modular Multiplication without trial division, Mathematics of calculation, 44(170) pp 519-521, April 1985).

A Montgomery multiplier makes it possible to perform the multiplications of the Mgt(M, B, N)=M·B·R⁻¹ mod N type. One advantage of this multiplier is its fast calculation. A drawback of this multiplier is that it introduces into the calculation a constant R, also called Montgomery's constant. R is a power of two, co-first with N:R=2ⁿ with n such that R has the same number of bits as N.

Montgomery's constant is intrinsic to the multiplier and it is necessary to eliminate its contribution upstream of the calculation during the calculation or at the end thereof. Thus, for calculating S=M·B mod N, M·R then Mgt(M·R, B, N)=M·B mod N can first be calculated for example. A first multiplication S₀=Mgt(M·R, B·R, N)=M·B·R mod N can also be performed and then a second multiplication can be performed of the S=Mgt(1, S₀, N) M·B mod N type.

The Montgomery multiplier also makes it possible to perform modular exponentiations of the S=MgtExp(M, B, N)=M^{B}·R^{-(B-1)} mod N or S=MgtExp(M·R, B, N)=M^{B}·R mod N types (in this case, the constant R^{-B} introduced by the calculation is compensated by multiplying M by R upstream of the calculation). Concretely, to perform a Montgomery exponentiation, an algorithm such as for example the one currently called “square and multiply” is performed, which consists in a loop indexed by i variant between q−1 and 0, 1 being the size of the number d, into a succession of multiplications of the Uᵢ=Mgt(Uᵢ₋₁, Uᵢ₋₁, N) and possibly Mgt(Uᵢ, M, N) (or Mgt(Uᵢ, M·R, N) types, depending on the value of a bit dᵢ of d associated with the index i, Uᵢ being a loop variable initialized to the value U_{q}=R. This exponentiation is explained in greater details in the document “Handbook of Applied Cryptography” by M. Menezes, P. Van Oorschot and S. Vanstone, CRC Press 1996, chapter 14, algorithm 14.94.

This exponentiation calculation has the advantage of being particularly fast.

Montgomery operations also have the following properties which will be used in the following:

Mgt(M, B, N)=M·B·R⁻¹ mod N

Mgt(M·R, B·R, N)=M·B·R mod N

Mgt(1, 1, N)=Mgt(N−1, N−1, N)=R⁻¹ mod N

Mgt(M, 1, N)=Mgt(N−M, N−1, N)=M·R¹ mod N

MgteXP(M·R, B, N)=M^{B}·R mod N

As seen above, Montgomery's multiplications and exponentiations introduce in the result a contribution which is a function of Montgomery's constant R. This constant can be eliminated at the end of each multiplication for example by performing a Montgomery multiplication by R² after the calculation. When this is possible, and more particularly for the exponentiations, it is easier to compensate a constant R upstream by multiplying the operand by the constant R rather than to compensate a power of R (a fortiori a negative power of R) at the output.

It should be noted that during the implementation of the above-mentioned method in cryptoprocessor, the same register or the same part of the memory can be used to store intermediate variables the names of which include the same letter: M₁, M₂ can be stored successively into a register M.

Of course, in the method explained in details hereabove, some steps can be shifted or exchanged with respect to each other. For example, in the step of initialization, sub-steps can be performed in a different order.

It should finally be noted that the method of the invention can be combined with prior methods to increase the security of the method.

For example, in addition to the masking of M, a random S2 can also be used to mask N, as described in the document D2 and the prior art of the present application. If the Chinese remainder theorem is used, p and q can be masked by S2.

1. A cryptographic method for decrypting or signing a message M, said method including a modular exponentiation, and comprising the following steps:
drawing a random value s,
initialization of variables with the aid of s,
application of an algorithm to the message M to obtain a result, which algorithm enables a loop invariant to be retained by virtue of the properties of the Montgomery multiplier Mgt, and
obtaining the signature or the decrypted version of the message M by unmasking of the result.

2. A method according to claim 1, wherein the step of initialization uses a value j, calculated by j=(3s)/2, a selected module N, the Montgomery variable R, and includes the initialization of at least five variables Acc, M₂, M₀, M₁ and M₃ in accordance with the following operations:
Acc←R^{s+1}·M mod N
M₂←R^{-j+1} mod N
M₀←R^{-3s+1} mod N
M₁←R^{-3s+1}·M mod N
M₃←R^{-3s+1}·M³ mod N

3. A method according to claim 2, wherein the algorithm includes, for each bit of the exponent d, the following steps,
squaring Acc←Mgt(Acc, Acc, N),
initialization of a variable k, so that k=dᵢdᵢ₋₁,
if k=2
Acc←Mgt(Acc, M₂, N)
Acc←Mgt(Acc, Acc, N)
if not
Acc←Mgt(Acc, Acc, N)
Acc←Mgt(Acc, Mₖ, N)
Shift two bits.

4. A method according to claim 1, wherein the step of initialization uses a selected module N, the Montgomery variable R and includes the initialization of at least four variables Acc, M₀, M₁ and M₃ in accordance with the following operations:
Acc←R^{s+1}·M mod N
M₀←R^{-s+1} mod N
M₁←R^{-s+1}·M mod N
M₃←R^{-3s+1}·M³ mod N

5. A method according to claim 4, wherein the algorithm includes, for each bit of the exponent d, the following steps:
squaring Acc←Mgt(Acc, Acc, N),
if the current bit is equal to 1 and the next bit too, then
Acc←Mgt(Acc, Acc, N)
Acc←Mgt(Acc, M₃, N)
shift two bits.
if the current bit is equal to 1 and the next bit is equal to 0, then
Acc←Mgt(Acc, M₁, N),
shift one bit.
if the current bit is equal to 0, then
Acc←Mgt(Acc, M₀, N),
shift one bit.

6. A method according to claim 5, wherein the unmasking operation includes at least the following operations:
calculation of R^{-s},
calculation of S=Mgt(Acc, R^{-s}, N), which corresponds to the signature of M or to the decrypted message.

7. A cryptoprocessor including a Montgomery multiplier that is configured to execute the following operations:
drawing a random value s,
initialization of variables with the aid of s,
application of an algorithm to a message M to obtain a result, which algorithm enables a loop invariant to be retained by virtue of the properties of the Montgomery multiplier Mgt, and
obtaining the signature or the decrypted version of the message M by unmasking of the result.

8. A chip card including a crytoprocessor according to claim 7.

9. A method according to claim 3, wherein the unmasking operation includes at least the following operations:
calculation of R^{-s},
calculation of S=Mgt(Acc, R^{-s}, N), which corresponds to the signature of M or to the decrypted message.

10. The method of claim 1, wherein said initialization step, application of the algorithm and obtaining step are performed in a cryptoprocessor.
